(19) United States
(12) Patent Application Publication
(10) Pub. No.: US 2005/0050666 A1
(43) Pub. Date: Mar. 10, 2005

(54) Hand roller device for removing or receiving or applying liquids from or to bases or for cleaning bases

(76) Inventor: Hermann Schumm, Wallhausen/Michelbach-Lucke (DE)

Correspondence Address: DARBY & DARBY P.C., P. O. BOX 5257, NEW YORK, NY, 10150-5257, US

(21) Appl. No.: 10/968,789

(22) Filed: Oct. 18, 2004

Related U.S. Application Data
(63) Continuation of application No. PCT/DE03/01122, filed on Apr. 5, 2003.

(30) Foreign Application Priority Data
Apr. 18, 2002 (DE) 102 17 445.8

(51) Int. Cl. B05C 17/02; B05C 17/035

(52) U.S. Cl. 15/230.11; 401/197; 401/208

(57) ABSTRACT

A hand-held roller device (10.1, . . . , 100) for removing and/or picking up and/or applying liquid, such as water, paint or the like, from or to substrates, having a handle profile region (12), an axle profile region (16), a deflection profile region (14) which runs between the handle profile region (12) and axle profile region (16), a roller device (20, 20.1) rotatably mounted on the axle profile region (16), is distinguished by the fact that the axle profile region (16) is surrounded by an elastic sponge body (60) which extends in the axle longitudinal direction, in the axle profile region (16), a first rotor unit (22) is provided on the inside in the transition region from the axle profile region (16) to the deflection profile region (14), on the outer end of the roller device (20), opposite the first rotor unit (22), there is a second rotor unit (26) which is rotatably mounted such that it can be displayed longitudinally on the axle profile region (16), a flexible pulling device (70) acts on the second rotor unit, is arranged within the axle profile section (16), the transition profile region (14) and the handle profile region (12) and, when it is acted on by means of a displacer unit (96) or a contrivance, axial longitudinal displacement of the second rotor unit (26) and therefore axial compression of the sponge body (60) take place.

### TECHNICAL FIELD

The present invention relates to a hand-held roller device for removing and/or picking up and/or applying liquid, such as water, paint or the like, from or to substrates, having a handle profile region, an axle profile region, a deflection profile region which runs between the handle profile region and axle profile region, and a roller device rotatably mounted on the axle profile region.

Hand-held roller devices of this type are used in many embodiments in households for cleaning purposes and/or paint application purposes.

### PRIOR ART

In the German utility model DE-U 73 33 567, a sponge with a handle-like grip is disclosed, the sponge body being held between holding elements in each case fixed at the ends to the outer part and an inner part, respectively, and being capable of being compressed by displacing the outer and inner parts. The compression of the sponge body is carried out counter to the force of a compression spring. The sponge itself is not designed to be rotatable. In the sponge body there is at least one recess, into which a detergent can be introduced, which is gradually dissolved under the action of water. As a result, detergent does not have to be put directly into the cleaning water.

DE-A 1 503 886 discloses a double sponge hand-held wiping device which, at the lower end of its wiper handle, has limbs which are connected and can be pivoted laterally and, at their ends, have round, short angled-over portions or pins which are horizontal in relation to each other and serve both as pressing elements and as sponge holders. By means of these pressing elements, the sponge can be compressed. In this case, the sponge is of rectangular design and no ability of the sponge to be rotated is provided.

British patent GB-A 704 348 discloses a device for wringing out sponges, the actual sponge body being arranged between two plates which can be moved toward each other. An ability of the sponge body to be rotated is not possible in this design.

U.S. Pat. No. 3,171,152 discloses a hand-held cleaning device having a sponge and body of triangular design. By means of manual displacement of a pressure disk in the axial direction, the sponge body can be pressed together, and therefore the liquid picked up in it can be applied. On account of its triangular design, an ability of the sponge body to be rotated is not possible.

U.S. Pat. No. 3,374,498 discloses a rectangular sponge body which, by means of a specific displacer unit displaceably mounted on a handle and having a flexible wall, can be displaced by a pressure plate onto a stationary pressure plate, as a result of which the sponge body arranged between them is pressed out.

BE 554652 describes a paint applicator roll which has a paint reservoir. In the wall of the roll there are recesses which can be closed by flaps. On the axis of rotation there is a collar which is connected via swinging arms to closure flaps. The collar can be displaced axially from the outside via a pull cable device, as a result of which the flaps are moved by the swinging arms and the recesses in the wall of the roll are opened in order to let paint through.

FR 1100842 discloses a paint application device in which the rotary part can be locked in a releasable manner via a clutch that can be disengaged in a form-fitting manner.

### SUMMARY OF THE INVENTION

On the basis of the aforementioned prior art, the object of the present invention is to specify a hand-held roller device of the type mentioned at the beginning which is constructed simply and functionally, can be produced economically, can be operated easily and can be set to the respective intended purpose by simple measures, be it that liquid is to be applied, that liquid is to be picked up or that the device is to be used as a wiping or cleaning device.

The hand-held roller device according to the invention is provided by the features of the independent claim 1.

Advantageous refinements and developments are the subject-matter of the dependent claims.

Accordingly, the hand-held roller device according to the invention is characterized in that the axle profile region is surrounded by an elastic sponge body which extends in the axle longitudinal direction, in the axle profile region, a first rotor unit is provided on the inside in the transition region from the axle profile region to the deflection profile region, on the outer end of the roller device, opposite the first rotor unit, there is a second rotor unit which is rotatably mounted such that it can be displaced longitudinally on the axle profile region, a flexible pulling device acts on the second rotor unit, is arranged within the axle profile section, the transition profile region and the handle profile region and, when it is acted on by means of a displacer unit or an contrivance, axial longitudinal displacement of the second rotor unit and therefore axial compression of the sponge body take place.

A particularly preferred, constructionally simple development is distinguished by the fact that the second rotor unit is connected to a second rotary bearing unit which is mounted on the axle profile region so as to be fixed against rotation but longitudinally displaceable and to which the pulling device is connected.

According to a first variant according to the invention, the hand-held roller device is accordingly distinguished by the fact that there are blocking means for the optional locking and unlocking of the rotational movement of the roller device. By means of this measure, a hand-held roller device normally conceived for the application of liquid, in particular paint, can also be used as a wiping or cleaning tool.

In this case, the blocking means can be operated, for example, manually or by a first contrivance that can be acted on by an operator. The contrivance is preferably formed as an electric motor.

A constructionally particularly simple refinement, which can be produced economically and ensures a permanently reliable function, is distinguished by the fact that a first rotor unit is connected to the roller device, at least at one end, is rotatably mounted on the axle profile region and has a first profile cross-sectional contour and, in the region of the first rotor unit, there is a blocking unit that is fixed against rotation and has a corresponding matching profile cross-sectional contour, it being possible, for the purpose of locking, for the first profile cross-sectional contour of the first rotor unit to be brought releasably into form-fitting engagement with the matching profile cross-sectional contour of the blocking unit.

A particularly advantageous refinement is distinguished by the fact that the first rotor unit has a circumferential flange and the first profile cross-sectional contour has at least one recess, in particular recesses present circumferentially in a predefined grid, and the matching profile cross-sectional contour of the blocking unit has a projecting unit which, depending on the rotational angle position of the first rotor unit, can be brought into engagement with the recess or one of its recesses.

Alternatively, the projecting unit can be arranged on a pivoting lever which can be locked in a locking and unlocking position and can be operated either by hand or, in the case of a hand-held roller device having a long handle, by foot.

A preferred refinement which is constructionally particularly simple, ensures a permanently reliable function and, at the same time, can be operated simply, is distinguished by the fact that the first/second rotary bearing unit is formed as a hub unit arranged to be fixed against rotation on the axle profile region. In this case, a further design variant can be implemented in a particularly advantageous way, being distinguished by the fact that there is a pivotable locking lever, which acts directly on the first rotor unit and, by means of its pivoting movement, the first profile cross-sectional contour of the first rotor unit can be brought out of engagement with the matching profile unit of the blocking unit.

A particularly preferred refinement, which can be produced economically, is distinguished by the fact that the handle profile region, the transition profile region and the axle profile region are formed as a single-piece hollow profile, the pulling device or Bowden cable preferably being arranged within the hollow profile, so that it is absolutely reliably protected against mechanical damage, contamination or the like effects which can impair its function.

In this case, the connection of the rotor unit and of the rotary bearing unit is preferably formed in a liquid-tight manner, so that the parts which can rotate are permanently reliably protected against contamination.

The connection of the second rotor unit or of the second rotary bearing unit to the rotor roll can be designed to be releasable, so that the rotor roll can be replaced without difficulty.

A very substantial advantage of the hand-held roller device according to the invention is that it can be used economically and in a time-saving manner as a cleaning tool. When the roller device is locked, the substrate to be cleaned is wiped over. Then, if the dirt holding volume of the sponge body is exhausted in the region in which it is in contact with the substrate, the roller device is unlocked in a simple manner, then rotated onward, for example by 45° (degrees of arc) and then locked again. The cleaning operation can then be continued. This procedure can be repeated for a total of eight times until virtually the entire circumferential contour of the sponge body is saturated with dirt. Only then is it necessary to dip the sponge body into a water container and then to compress said sponge body for cleaning purposes.

The pulling device can also be formed in a simple manner as a pull cable, but for this purpose there must be deflection rollers within the profile regions, in particular in the deflection profile region.

In order to ensure a permanently reliable function in which the extension movement of the sponge body following compression is advantageously assisted, a preferred embodiment is distinguished by the fact that a first elastic unit, in particular a spiral spring, is arranged between the first rotor unit and the second rotor unit.

Furthermore, a second elastic unit, in particular a spiral spring, can also be arranged between the first rotary bearing unit and the second rotary bearing unit.

It is constructionally particularly advantageous, according to a preferred refinement, to construct the hand-held roller device in such a way that the first rotary bearing unit and/or the second rotary bearing unit is/are formed as a hub unit mounted on the axle profile region so as to be fixed against rotation but longitudinally displaceable.

In this case, according to the invention the hand-held roller device is distinguished by the fact that the hub unit has a guide projection unit which points inward, engages in a slot running axially and present in the axle profile region and to which the pulling device or the Bowden cable is anchored.

A particularly advantageous refinement of the hand-held roller device according to the invention is distinguished by the fact that the axle profile region is of telescopic design, so that, when the sponge body is compressed, there is no projecting axle profile region.

In an alternative refinement, the transition profile region is not formed as a curved hollow profile but as a housing profile, which means that the possibility of accommodating contrivances and/or deflection units for a pulling device in said profile is advantageously opened up.

A particularly advantageous design variant, which permits particularly simple operation, is distinguished by the fact that the displacer unit is formed as a handgrip which is arranged in the handle profile region such that it can be locked releasably.

In order to reduce the force needed to compress the sponge body, a preferred refinement is distinguished by the fact that there is a third elastic unit, which is formed in particular as a spiral spring, which places the displacer unit or the handgrip under tensile stress in such a way that the necessary pulling force for pressing out the sponge body is reduced.

All the profile regions can consist of plastic or metal. The elastic sponge body is preferably formed as a viscose sponge which, with respect to its liquid-absorbing action, achieves very good results.

A roller device which is particularly simple to handle is distinguished by the fact that the handle profile region is arranged substantially at right angles to the axle profile region.

In an alternative refinement, the first rotor unit is also formed in the longitudinal-displacement direction in relation to the second rotor unit, so that compression of the sponge body can also be carried out from this side.

Further embodiments and advantages of the invention emerge through the features listed further in the claims and also through the exemplary embodiments specified below. The features of the claims can be combined with one another in any desired manner, to the extent that they are not obviously mutually exclusive.

### BRIEF DESCRIPTION OF THE DRAWING

The invention and advantageous embodiments and developments of the same will be described and explained in more detail in the following text by using examples illustrated in the drawing. The features to be gathered from the description and the drawing can be applied individually on their own or in a plurality in any desired combination, according to the invention. In the drawing:

FIG. 1 shows a schematic illustration of a hand-held roller device having a compressible sponge body,

FIG. 2 shows a schematic illustration with cross-sectional and elevation illustrations, linked by means of arrows, of a first exemplary embodiment of a hand-held roller device having a compressible sponge body and a first embodiment of a blocking unit,

FIG. 3 shows an associated sponge body for the device according to FIG. 2 in longitudinal section and in a side view,

FIG. 4 shows a schematic, detailed side view of an embodiment of the handle region of the hand-held roller device recording to FIG. 2,

FIG. 5 shows a schematic illustration of a third exemplary embodiment of a hand-held roller device having a compressible sponge body and a third embodiment of a blocking unit,

FIG. 6 shows a schematic illustration of the detail A according to FIG. 5,

FIGS. 7a, b, c show schematic cross-sectional and longitudinal sectional illustrations of a rotary bearing unit according to the device of FIG. 5, which is formed at the same time as a blocking unit,

FIGS. 8a, b, c show schematic cross-sectional and longitudinal sectional illustrations of a rotor unit rotatably mounted on the rotary bearing unit according to FIG. 7, which can be brought into engagement with the rotary bearing unit in a form-fitting manner for blocking purposes,

FIG. 9 shows a schematic detailed sectional illustration of the detail B according to FIG. 5,

FIGS. 10a, b, c show schematic views of two circlips used in the region of a handgrip,

FIGS. 11a, b, c show schematic longitudinal and cross sections of a handgrip unit which can be expanded,

FIGS. 12a, b, c, d show a schematic angled-over side view and a cross-sectional illustration of an expanding lever for the handgrip according to FIGS. 11a, b, c,

FIG. 13 shows a schematic sectional illustration through a fourth exemplary embodiment of a hand-held roller device having a compressible sponge body and a fourth embodiment of a blocking unit,

FIG. 14 shows a schematic sectional illustration of the hand-held roller device according to FIG. 13 when using a contrivance,

FIG. 15 shows a schematic sectional illustration of a hand-held roller device having a short handle region when using a contrivance,

FIGS. 16a, b show a schematic sectional illustration of the hand-held roller device according to FIG. 2 in various compressed states of the sponge body in order to introduce liquid into a container,

FIG. 17 shows a schematic sectional illustration of the use of a hand-held roller device according to FIG. 5, in which liquid is being moved from a container into a second container by means of the hand-held roller device,

FIG. 18 shows a schematic sectional illustration through a further exemplary embodiment of the hand-held roller device, having a compressible sponge body and a blocking unit, the housing profile being arranged between the handle profile region and the axle profile region of the hand-held roller device and the compression and blocking being carried out manually,

FIG. 19 shows a schematic illustration of the detail D according to FIG. 18,

FIG. 20 shows a schematic cross-sectional illustration of the detail D according to FIG. 18, but contrivances being used for compressing and blocking the sponge body,

FIG. 21 shows a schematic side view in a transparent illustration in the direction of the arrow S according to FIG. 20,

FIG. 22 shows a schematic plan view of a spring locking unit for locking the pivoting lever of the first blocking unit according to FIG. 2,

FIG. 23 shows a schematic sectional illustration through the detail C according to FIG. 2, and

FIG. 24 shows a schematic detailed sectional illustration of a further exemplary embodiment of a hand-held roller device, similar to that of FIG. 5, but in which a locking lever, which acts on a rotor unit, is used for blocking purposes.

### PREFERRED EMBODIMENTS OF THE INVENTION

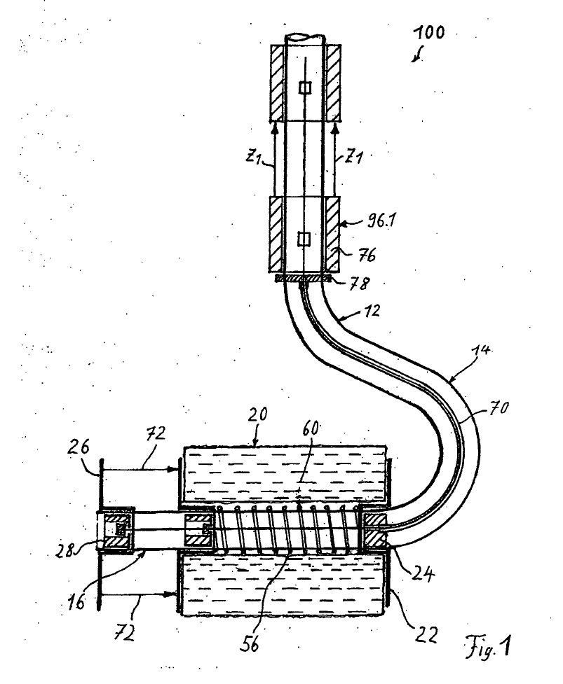

In FIG. 1, a hand-held roller device 100 is illustrated schematically in section, having a rotatable roller device 20 with an elastic cylindrical sponge body 60, the sponge body 60 being compressible.

The compression function will be described in principle in the following text.

The hand-held roller device 100 has a rectilinear handle profile region 12, an adjacent transition profile region 14, which initially runs obliquely downward and then runs in a curve through about 180° (degrees of arc), and a rectilinear axle profile region 16 which adjoins the transition profile region 14. The profile regions 12, 14, 16 are formed by a single-piece, curved round tubular profile. The axle profile region 16 is substantially at right angles to the handle profile region 12. In the transition region between the transition profile region 14 and the axle profile region 16 there is a first rotary bearing unit 24 which is fixed against rotation on the axle profile region 16 and on which a first rotor unit 22 is rotatably mounted. The first rotor unit 22 has a projecting circumferential flange 30, which bears on the sponge body 60 at the end. Furthermore, integrally molded on the flange 30 in the direction of the sponge body 60 are fixing pins 31, which fix the sponge body to the first rotor unit 22. It is also possible to omit the fixing pins.

In the opposite outer end region of the axle profile region 16 there is a second rotary bearing unit 28 fixed against rotation, which can be displaced longitudinally in the axial direction and on which a second rotor unit 26 having a circumferential flange 30 is rotatably mounted. By means of this formation, the ability of the roller device 20 to rotate about the axle profile region 16 is permanently reliably ensured.

The compressibility of the sponge body 60, which is preferably formed as a viscose sponge, is ensured by the following components. On the handle profile region 12 there is a displacer unit 96.1 which can be displaced longitudinally and which is formed as a handgrip 76. The handgrip 76 can be displaced downward as far as a stop unit 78. Within the handle profile region 12, the transition profile region 14 and the axle profile region 16 there is arranged a flexible pulling element 70, which is formed as a Bowden cable 70. One end of the cable of the Bowden cable 70 is anchored to the handgrip 76. One end of the sheath of the Bowden cable 70 bears on the stop unit 78. The other end of the cable of the Bowden cable 70 is anchored to the second rotary bearing unit 28. The other end of the sheath of the Bowden cable 70 is connected to the first rotary bearing unit 24. Arranged between the first rotor unit 22 and the second rotor unit 26 is a first elastic unit 56, which is formed as a helical spring. It is also possible to omit the first rotary bearing unit. In this case, the first rotor unit is rotatably mounted directly on the axle profile region.

If, then, the handgrip 76 is pulled upward along the handle profile region 12 in the direction of the arrow Z1, this displacement is transmitted via the Bowden cable 70 to the second rotary bearing unit 28 and therefore also to the second rotor unit 26, so that the latter are moved in the direction of the arrow Z2 and, counter to the action of the first elastic unit 56 and the elasticity of the sponge body 60, compress the latter, so that liquid picked up previously in the sponge body 60 is pressed out of the latter.

If, following the compression of the sponge body 60, the handgrip 76 is released, then the sponge body 60 expands again because of its elastic material property and with the assistance of the elastic unit 56, so that the handgrip 76 is displaced downward until it strikes the stop unit 78. In this state, the sponge body 60 is completely relieved of stress and can be used to pick up further liquid for further cleaning purposes.

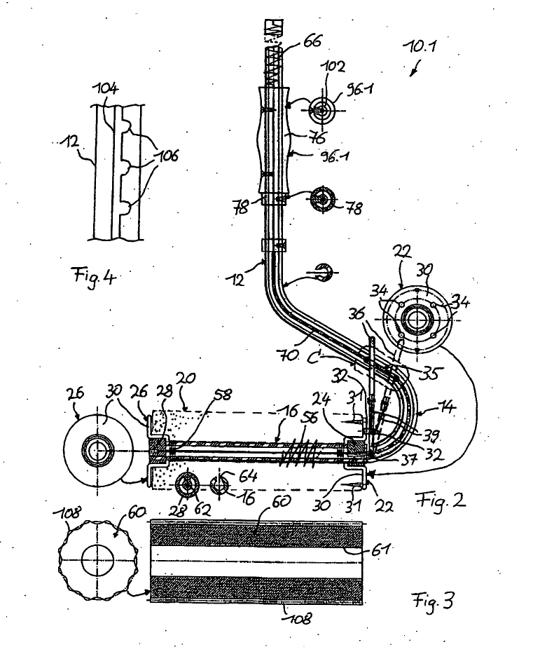

In FIG. 3, a first constructional design variant of a hand-held roller device 10.1 which implements the above principle is illustrated. Identical components bear the same designations and will not be explained again.

The first and second rotor units 22, 26 are formed in the shape of pots with a projecting flange 30, the first and, respectively, second rotary bearing units 24, 28 being arranged within the pot. The rotary bearing units 24, 28 are formed as hub units. The second rotary bearing unit 28 has a guide projection unit 62 which points inward, engages in a slot 64 present in the axle profile region 16 and at the same time is used to anchor the cable of the Bowden cable 70. Thus, the second rotary bearing unit 28 forms the rotary bearing for the second rotor unit and, firstly, is fixed against rotation and, secondly, can be displaced longitudinally on the axle profile region 16.

In support, between the first rotary bearing units 24 and the second rotary bearing units 28, there can be a second elastic unit 58, which is preferably formed as a helical spring.

The displacer unit 96.1 is formed as a sleeve unit around the profile region 12 and has a projecting unit 102 which points inward and on which one end of the Bowden cable 70 is anchored. The projecting unit 102 is guided within a slot 104 present on the web profile region 12.

In a design variant illustrated schematically in FIG. 4, the slot 104 has transverse recesses 106 arranged spaced apart in the manner of a grid, into which the projecting unit 102 can be brought into engagement in a form-fitting manner, so that the displacer unit 96.1 can be locked on the handle profile region 12 in virtually any desired position.

In order to reduce the expenditure of force for pressing out the sponge body 60, according to a preferred design variant, between the displacer unit 16.1 and the upper end region of the handle profile region 12 there is a third elastic unit 66, which is preferably formed as a helical spring, which places the displacer unit 26.1 under tensile stress when it is resting on the stop unit 78.

In FIG. 3, the elastic sponge body 60 is illustrated in a longitudinal section and a side view. The cylindrical circumferential contour has a wavy contour 108 superimposed on it. Furthermore, the sponge body 60 has a continuous cylindrical inner recess 61. The axle profile region 16 with first elastic unit 56 is arranged in this inner recess 61.

The hand-held roller device 10.1 also has a blocking unit, by means of which the rotational movement of the roller device 20 can be locked or unlocked as desired. The blocking unit has a pivoting lever 36, which is formed as a U-shaped loop and whose web end regions are arranged such that they can rotate about an axis of rotation 37 at right angles to the axial direction of the axle profile region 16. The pivoting lever 36 can be pivoted from a locking position into an unlocked position about the axis of rotation 37, the unlocked position being illustrated dashed in FIG. 2. On the pivoting loop 36 there is a collar element 39 which is arranged to be inclined with respect to the longitudinal axis of the pivoting loop 36 and at whose free end a projecting unit 32 is integrally molded. At the same time, the first rotor unit 22 has four continuous recesses 34 in its flange 30 which are offset through 90° (degrees of arc) in the circumferential direction and with which the projecting unit 32 can be brought into form-fitting engagement, depending on the positioning. In order to block the roller device 20, the pivoting lever 36 is pivoted from the unlocked position (dashed illustration) into the locking position (continuous illustration). If the projecting unit 32 does not encounter a recess 34, then it initially rests on the outer surface of the flange 30, pressing elastically on account of the inclined arrangement of the collar element. By means of slight rotation of the roller device 20, the projecting unit 32 can be brought into coincidence with a recess 34, so that the projecting unit 32 then latches into the recess 34 and the blocking state is provided, since the first rotor unit 22 can then no longer rotate.

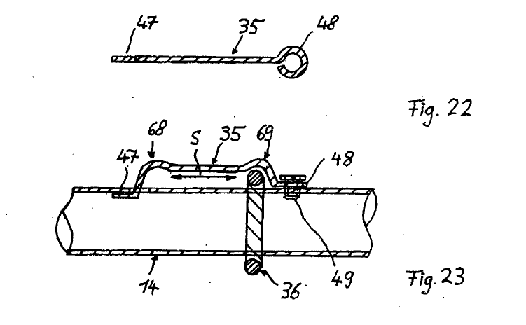

The fixing of the pivoting lever 36 in the unlocked and locking position (detail C in FIG. 2) is illustrated in more detail in FIGS. 22 and 23, respectively. The loop-shaped pivoting lever 36 engages around the transition profile region 14. Connected to the outside of the transition profile region 14 is a clamping spring unit 35, whose one end 47 engages under the outer wall of the transition profile region 14 and whose other end 48 is fixed by means of a screw 49 to the outside of the transition profile region 14. A web of the pivoting lever 36 is arranged between the outer wall of the transition profile region 14 and the inner wall of the clamping spring unit 35. In the unlocked position 67 and in the locking position 68, the distance between clamping spring units 35 and transition profile region 14 is chosen to be slightly greater than the diameter of one loop of the pivoting lever 36. Between the two positions 67, 68, the distance is chosen to be smaller, so that the pivoting lever can be pivoted from one position into the other only by the application of a force (arrow S), that is to say reliable locking of the respectively desired position is ensured.

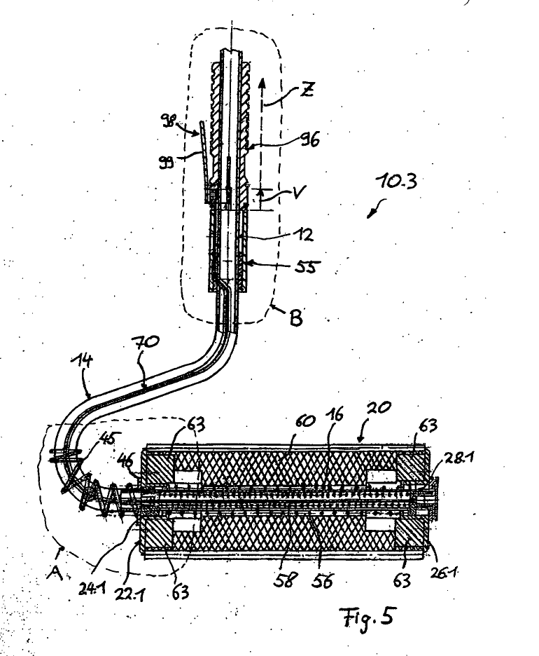

The third design variant of a hand-held roller device 10.3, illustrated in FIG. 5, operates in accordance with the same principle as the devices described above in order to compress the roller body 20, but the blocking action is produced in a different manner and the displacer unit 96 is formed in a different way.

The blocking action is produced by the first rotor unit 22.1, 26.1 being brought into form-fitting engagement with the first and/or second rotary bearing unit 24.1, 28.1. The first rotor unit 22.1 is illustrated in FIG. 5. Instead of the pins, the rotor unit 22.1 has wall elements 63 which point inward, are distributed circumferentially through 90° (degrees of arc) and are integrally molded on the flange 30, which engage in corresponding recesses present in the sponge body 60. Integrally molded in the base of the pot of the rotor unit 22.1 are projecting units 41 present circumferentially in the manner of a grid.

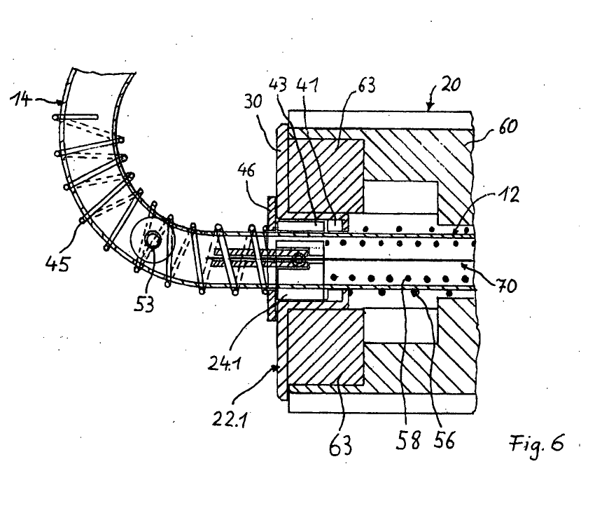

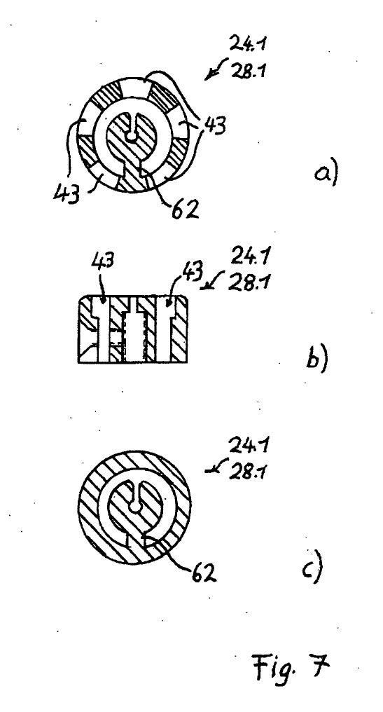

Arranged in the pot region of the first rotor unit 22.1 is the first rotary bearing unit 24.1, which is illustrated in FIG. 6. On the side facing the latching projections 41, it has corresponding latching recesses 43, into which the latching projections 41 can be brought into form-fitting engagement by means of a relative displacement of the two components, as soon as the rotary position of the two components agrees appropriately. The second rotor unit 26.1 and the second rotary bearing unit 28.1 are formed accordingly. As opposed to the first rotary bearing unit 24.1, the second rotary bearing unit 28.1 is mounted on the axle profile region 16 such that it can be displaced longitudinally. These rotary bearing units also have an integrally molded projecting unit 62 which points inward, engages in the slot 64 in the axle profile region 16 and to which, in the case of the second rotary bearing unit 28.1, the cable of the Bowden cable 70 is anchored.

If the sponge body 60 is in the unstressed state, the latching projections 41 of the rotor units 22.1 and 26.1 are disengaged from the latching recesses 43 of the first rotary bearing units 24.1 and 28.1, respectively, that is to say rotation of the roller device 20 is possible.

If the blocking action is to be produced, the displacer unit 96 is displaced upward by the dimension B (see FIG. 5), this displacement movement being transmitted via the Bowden cable 70 to the second longitudinally displaceable rotary bearing unit 28.1. As a result, there is firstly a relative displacement between the second rotary bearing unit 28.1 and the second rotor unit 26.1, so that the latching projections 41 of the second rotor unit 26.1 engage in a form-fitting manner in the latching recesses 43 of the second rotary bearing unit 28.1, likewise with slight simultaneous rotation of the roller device 20. In this state, the rotationally fixed second rotary bearing unit 28.1 is coupled in a form-fitting manner to the second rotor unit 26.1, that is to say rotation of the roller device 20 is no longer possible.

In the inner region, on the outside in the transition profile region 14, there is an elastic spring element 45, which is formed as a circumferential helical spring, which is supported on the transition profile region 14 by a projecting unit 53 and by a displaceable disk 46 in the end region of the first rotor unit 22.1. When the displacer unit 96 is displaced upward by the dimension V (FIG. 5), the latching projections 41 and latching recesses 43 of the first rotor unit 22.1 and, respectively, the first rotary bearing unit 24.1 come into engagement. By means of the spring element 45, it is possible to set the necessary force for displacing the displacer unit 96. This is done in a simple manner by rotating the helical spring 45. The spring element 45 has the effect that, when it is unblocked, the first rotor unit 22.1 comes out of engagement with the rotary bearing unit 24.1, since its spring force is greater then the spring force of the first elastic unit 56 arranged between the rotor units 22.1, 26.1.

It is also possible for the blocking to take place only on one end of the roller device. For example, the first rotary bearing unit can be formed as a normal stationary unit, on which the first rotor unit is arranged such that it can rotate. The spring element 45 can then be omitted completely.

In the handle profile region 12, underneath the displacer unit 96, there is connected a series connection sleeve 55, which is used firstly as a lower stop for the displacer unit 96 and within which the Bowden cable 70 is led out of the interior of the web profile region 12 and the cable of the Bowden cable 70 is led further upward as far as the anchoring position on the displacer unit 96.

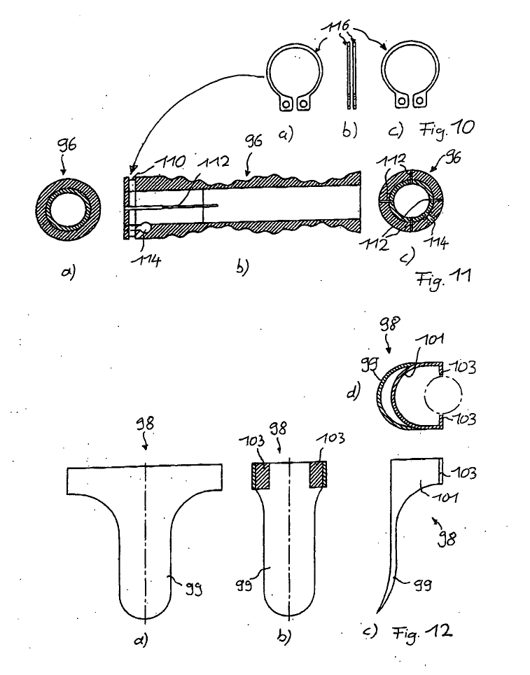

The displacer unit 96 is illustrated in more detail in FIGS. 11a, b, c. In some regions, it is formed as an expanding unit. In its lower end region, the displacer unit 96 has an embossed circumferential groove 110, in which two securing rings or circlips 116 which can be expanded elastically are arranged (see FIGS. 10a, b, c), which ensure that the displacer unit 96 is reliably locked in a clamping manner on the handle profile region 12.

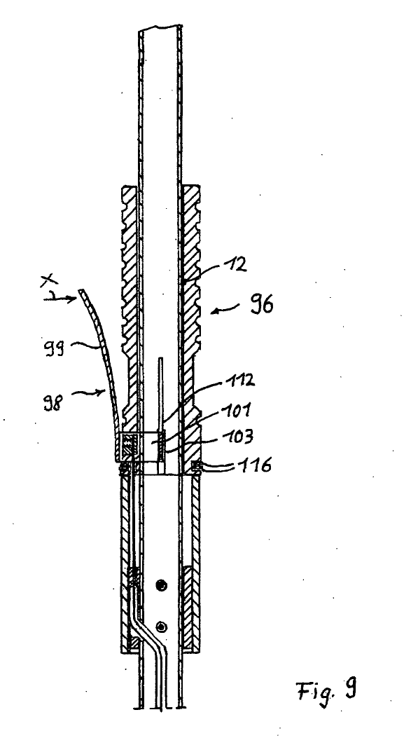

The displacer unit 96 has four slots 112 which are offset radially by 90° (degrees of arc) in the circumferential direction and are open at the bottom. The bottom anchoring position of the cable of the Bowden cable 70 on the displacer unit 96 is indicated by the designation 114 in FIG. 11b). In order to permit the displacement of the displacer unit 96, which is simultaneously formed as a handgrip, along the handle profile region 12, the expansion lever 98 illustrated in detail in FIGS. 12a to d is inserted. The expansion lever 98 has a grip region 99 which is inclined outward and a shaped region 101 which is integrally molded on the underside and embraces the handle profile region 12 semicircularly. In its end region, the shaped region 101 has turned-over edge regions 103 running inward at right angles, these two mutually opposite turned-over edge regions 103 engaging in the opposite slots 112 of the displacer unit 96. If, then, pressure is exerted on the grip region 99 in the direction of the arrow X (see FIG. 9), this leads to expansion in the region of the circlips 116 on account of the lever action, so that the displacer unit can be displaced as a whole in the longitudinal direction on the handle profile region 12, for example in the direction of the arrow Z (FIG. 5), in order to compress the sponge body. As soon as the expansion lever 98 is released, the circlips 116 again ensure that the displacer unit is securely locked to the handle profile region 12 in this instantaneous position.

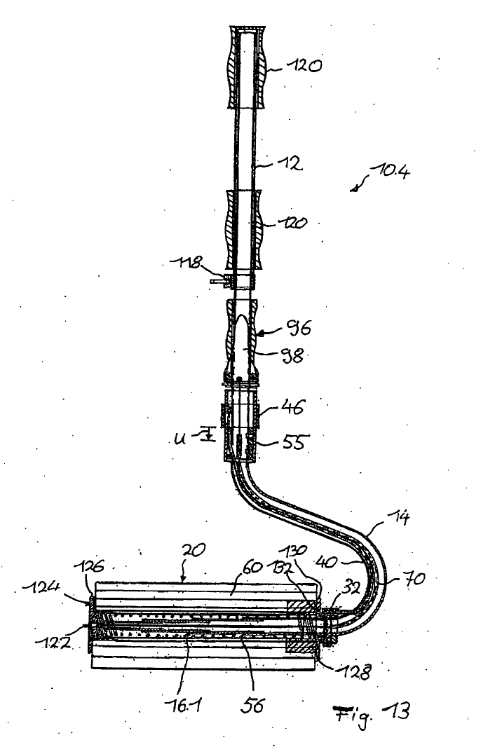

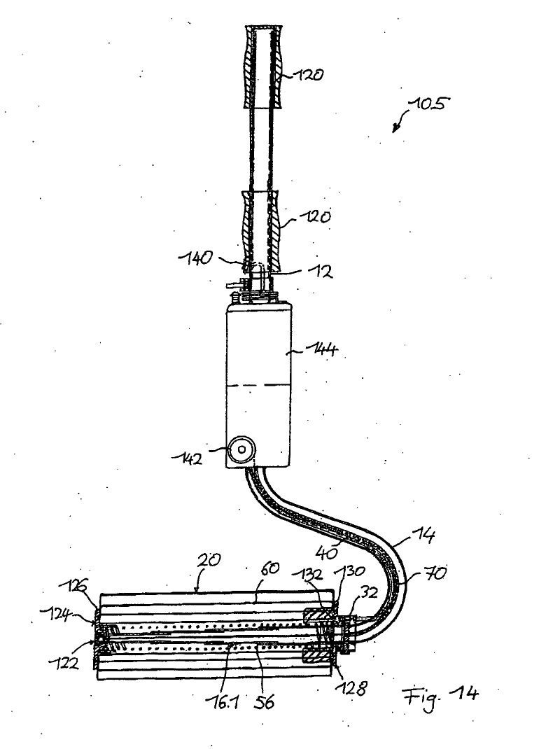

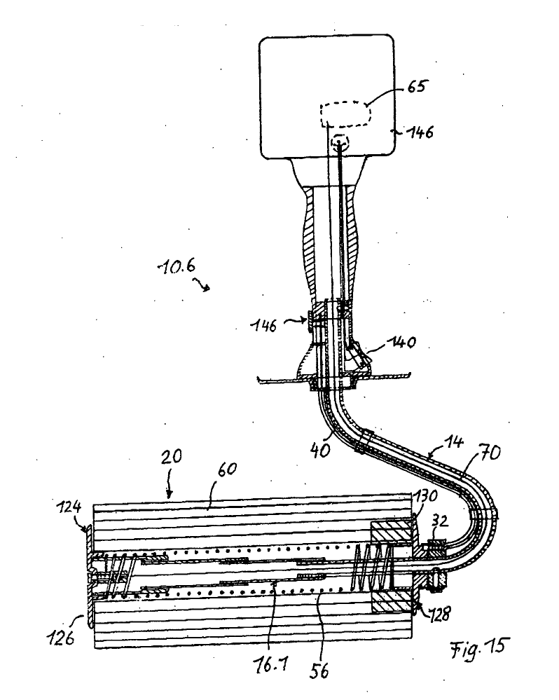

FIG. 13 illustrates a fourth exemplary embodiment of a hand-held roller device 10.4, in which the handle profile region 12 is of telescopic design, the telescope tubes being locked by an eccentric lever unit 118. In the telescoping region, there are two further handgrips 120. As distinct from the hand-held roller devices described above, here the axle profile region 16.1 itself can be telescoped, that is to say it is not necessary for there to be a second rotary bearing unit 122, which must be present on the axle profile region 16.1 such that it can be displaced longitudinally, in order to compress the sponge body 60. The cable end of a Bowden cable 70 is likewise anchored to the “stationary” second rotary bearing 122 and is operatively connected at its other end to the displacer device 96. On the second rotary bearing unit 122, a second rotor unit 124 having a circumferential flange 126 is mounted such that it can rotate.

On the end opposite the free end of the roller device 20, a first rotor unit 128 is rotatably mounted on the telescopic axle profile region 16.1. The first rotor unit 128 likewise has a flange 130 with continuous recesses 132, it being possible for an existing pin 32, which is operatively connected to a further Bowden cable 40, to be introduced into one of these recesses 132 for blocking purposes, the other end of the Bowden cable being connected to a further displacer unit 46, which is arranged on the series connection sleeve 55 such that it can be displaced in the longitudinal direction. In order to block the roller device 20, in the case of the hand-held roller device 10.4 according to FIG. 13, it is therefore necessary for a further displacer unit 46 to be displaced downward in the direction of the arrow U, as a result of which, by means of the Bowden cable 40, the pin 32 is extended and latches into one of the recesses 132.

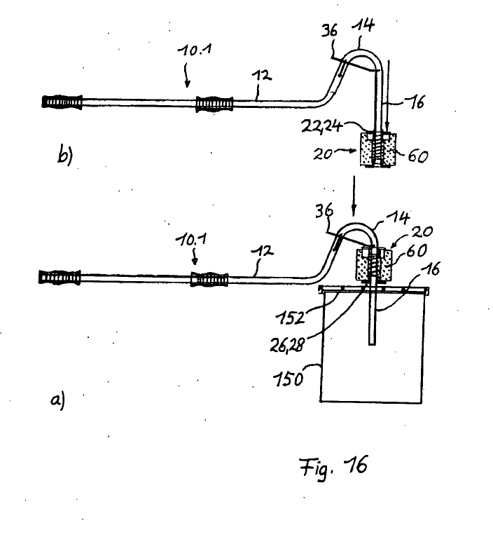

FIG. 14 illustrates a fifth design variant of a hand-held roller device 10.5 which, in principle, has the same construction as the hand-held roller device 10.4 according to FIG. 13. Therefore, identical components bear the same designations and will not be explained again. The essential difference is that, in order to produce the movement of the Bowden cable, use is not made of the displacer unit 96 and/or the further displacer unit 46 but of a contrivance 144, in particular an electric motor, which can be driven via corresponding switching units 140 and 142 in order to unlock and to lock the roller device 20 or to compress the sponge body 60.

The sixth design variant of a hand-held roller device 10.6, illustrated in FIG. 15, resembles in its construction the hand-held roller device 10.4 according to FIG. 13 and likewise has a telescopic axle profile region 16. Both rotor units 124, 128 are directly rotatably mounted on the axle profile region 16.1. However, in this embodiment, the handle profile region 12 is kept relatively short and the compression of the sponge bodied 60 is carried out via a contrivance 146 which is present in the upper end region of the handle profile region 12 and acts on the second rotor unit 124 via the Bowden cable 70. The blocking is likewise carried out via the pin 32 that is acted on by the Bowden cable 40, the displacer unit 46 connected to the other end of the Bowden cable 40 being of slightly different constructional design, specifically as a slider switch. Instead of the contrivance 146, there can also be a pull ring 65 connected to the Bowden cable (dashed illustration in FIG. 15), which is operated manually.

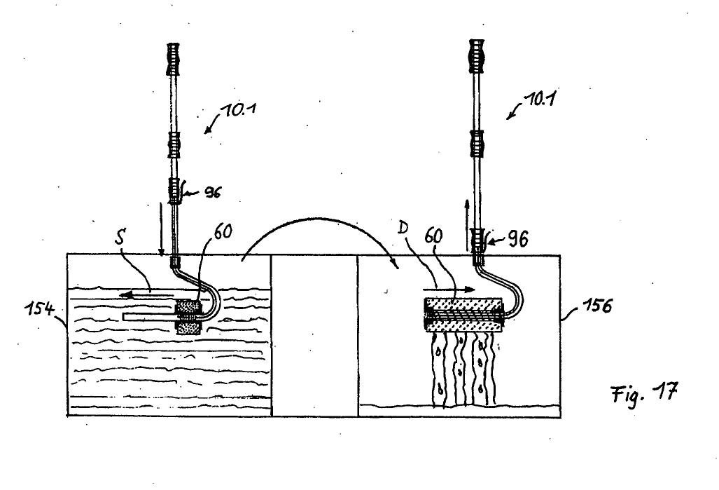

FIG. 16 a shows in schematic form the compression of the sponge body 60 by means of linear displacement of the second rotor unit 26 and the second rotary bearing unit 28 in order to empty the liquid into a container 150 which has a mesh or grille 152 at the top. According to FIG. 16b, it is also possible to form the first rotor unit 22 and the first rotary bearing unit 24 such that they can be displaced longitudinally, so that manual compression of the sponge body 60 is also possible as a result.

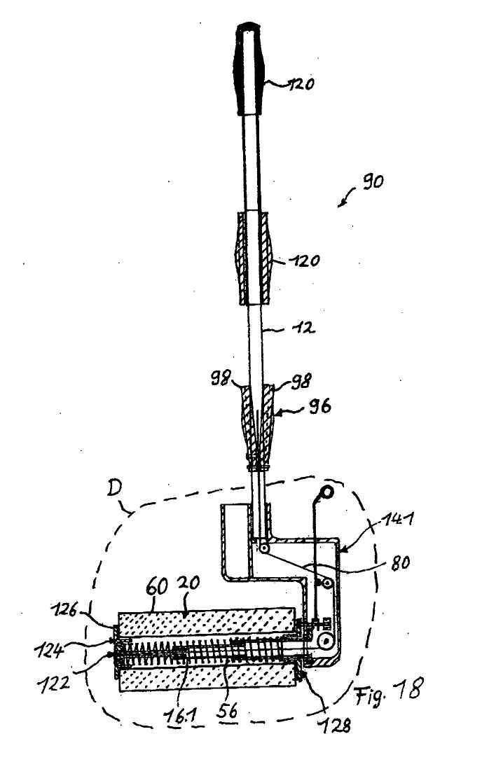

FIG. 17 illustrates schematically how, by means of the hand-held roller device 10.1 described, liquid can be removed from a first container 154 and transferred into a second container 156. For example, first of all the hand-held roller device 10.1 is introduced into the first container 154 below the liquid level with the sponge body 60 compressed and the sponge body 60 is then relieved of stress (arrow S). As a result, it picks up liquid. In this state, the hand-held roller device 10.1 is moved into the second container 156 and the sponge body 60 is then compressed by displacing the displacer unit 96 (arrow D), so that the liquid sucked up emerges into the second container 156.

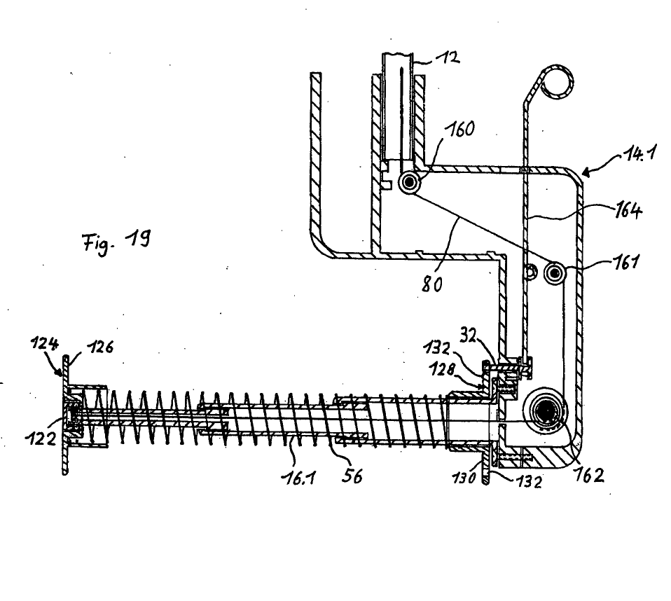

FIGS. 18 and 19 illustrate a further embodiment of a hand-held roller device 90, whose mode of action substantially corresponds to the mode of action of the hand-held roller device 10.4 according to FIG. 13 having a telescopic axle profile region 16.1, but use being made of a transition profile region 14.1 which is formed as a housing profile, and the Bowden cable having been replaced by a simple pull cable unit 80, which is fed to the second rotary bearing unit 122 over deflection rollers 160, 161, 162 within the housing profile 14.1. The blocking action is likewise made possible via a pin 32 which is longitudinally displaceably mounted on the housing profile 14.1 and which can be brought into engagement in a recess 132 of the first rotor unit 128, a spring lever 164 which is accessible from outside the housing profile 14.1 and can be locked in an unlocked and locking position, respectively, on the housing profile 14.1 acting on the pin 32.

The housing profile 14.1 is connected to the telescopic axle profile region 16.1 in a liquid-tight manner.

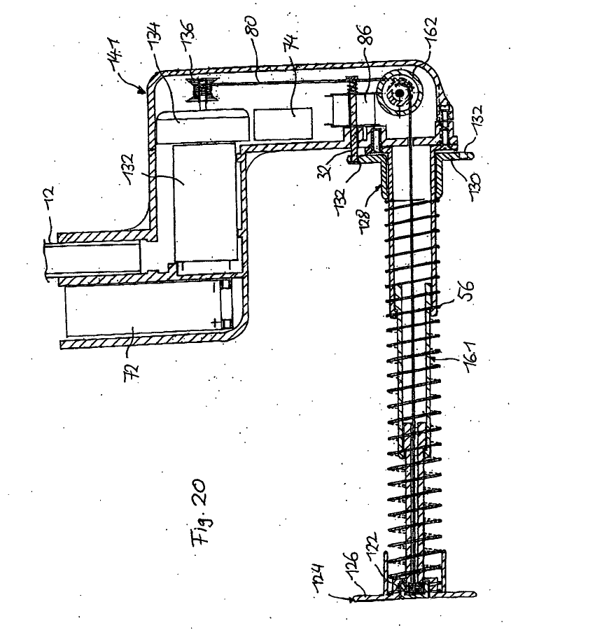

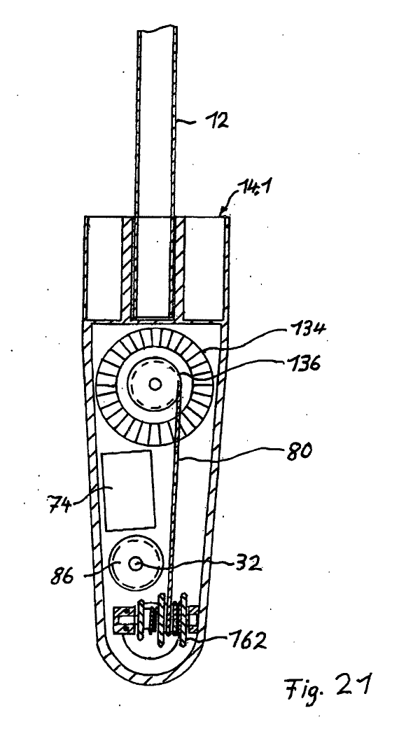

Finally, a further embodiment of a hand-held roller device 100 is illustrated in the lower region in FIG. 20, in which likewise the housing profile 14.1 according to the previous embodiment is used, but the movements of the pull cable unit 80 being carried out by a second contrivance 132 with a gearbox 134 connected in front, it being possible for the pull cable unit 80 to be wound onto/unwound from a reel 136 and fed to the second rotary bearing unit 122 over the deflection roller 162. In a corresponding way, the pin 32 displaceably mounted on the housing profile 14.1 is assigned a first contrivance 86, which arranges for said pin 32 to be retracted and extended for the purpose of locking and unlocking the rotational movement of the roller unit 20. Also illustrated in FIG. 20, in the upper left region of the housing profile 14.1 there is a chamber 72, within which there is a rechargeable battery 138 which supplies the contrivances 132, 86 formed as electric motors, with power. Illustrated schematically in FIG. 20, inside the housing profile 14.1, is a relay 74, not all of the electronic circuitry and wiring being illustrated specifically in FIG. 20. The contrivances 132 and 86 are acted on via manually operated switching units which are not specifically illustrated in FIG. 20 but are preferably arranged on the handle profile region 12.

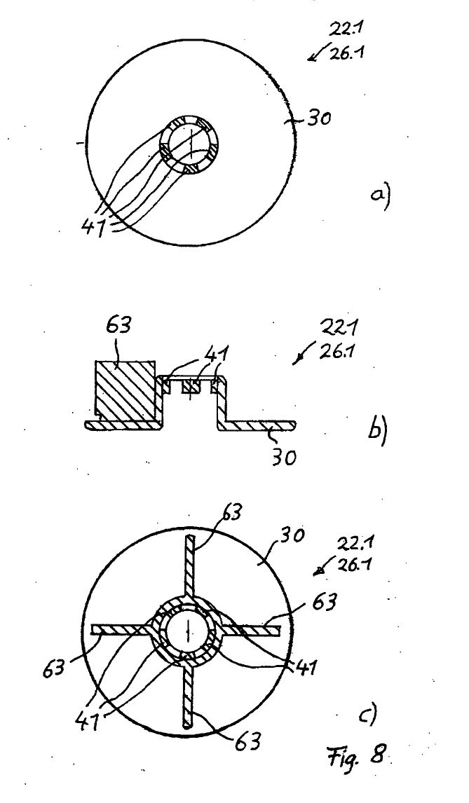

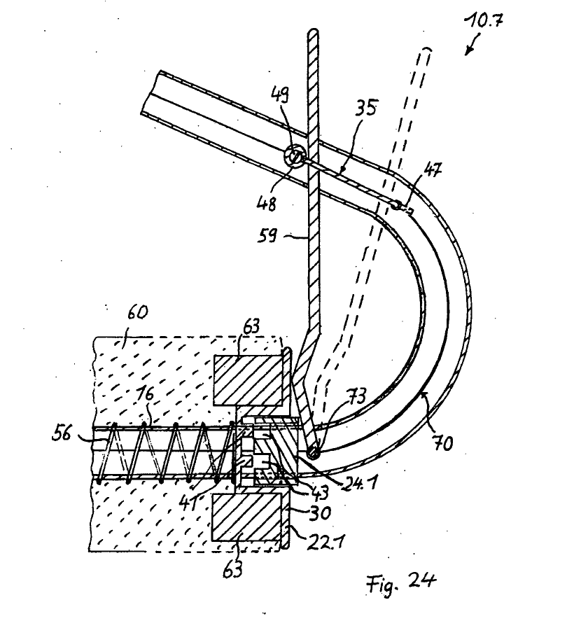

FIG. 24 illustrates a further exemplary embodiment of a hand-held roller device 10.7 as a detail, which shows a further constructional design variant with respect to the blocking unit. In the right-hand end region of the axle profile region 16, the first rotary bearing unit 24.1 already described above (FIG. 7) is arranged so as to be fixed against rotation. On the first rotary bearing unit 24.1, the first rotor unit 22.1 likewise already described above (FIG. 8) is arranged such that it can rotate and can be displaced in the longitudinal direction. On the flange 30 of the first rotor unit 22.1 there acts a locking lever 59 which is connected in an articulated manner via an articulation point 73 in the transition region between transition profile region 14 and axle profile region 16 and which can be locked in two pivoted positions via the clamping spring unit 35 (FIGS. 22, 23) likewise already described above.

When the locking lever 59 is in the left-hand (continuous) position in FIG. 24, the first rotor unit 22.1 is displaced with respect to the first rotary bearing unit 24.1 in such a way that the latching projections 41 of the first rotor unit 22.1 are disengaged from the latching recesses 43 of the first rotary bearing unit 24.1, that is to say the roller device, not specifically illustrated in FIG. 24, can be rotated freely.

If, then, the locking lever 59 is pivoted into the right-hand (dashed) position in FIG. 24, the latching projections 41 latch into the latching recesses 43 on account of the action of the first elastic unit 56 or the elastic properties of the sponge body, and the roller unit is blocked overall. This embodiment can be implemented in a particularly simple way in constructional terms, ensures simple operation, a permanently reliable function and permits economic production.

In an exemplary embodiment that is not specifically illustrated, the provision of a first rotary bearing unit is dispensed with. The first rotor unit is directly rotatably mounted on the axle profile region and has a circumferential flange projecting in the axle longitudinal direction and having recesses which are open to the outside, which can be arranged to be distributed circumferentially in the manner of a grid. The locking lever is formed as a loop which, at the level of the articulation point, has projections pointing inward on both sides which, for blocking purposes, given appropriate lever actuation and position of the first rotor unit, can be brought into engagement with the recesses of the flange.

1. A hand-held roller device (10.1, . . . , 100) for removing and/or picking up and/or applying liquid, such as water, paint or the like, from or to substrates, having
a handle profile region (12),
an axle profile region (16),
a deflection profile region (14) which runs between the handle profile region (12) and axle profile region (16),
a roller device (20, 20.1) rotatably mounted on the axle profile region (16),
characterized in that
the axle profile region (16) is surrounded by an elastic sponge body (60) which extends in the axle longitudinal direction,
in the axle profile region (16), a first rotor unit (22) is provided on the inside in the transition region from the axle profile region (16) to the deflection profile region (14),
on the outer end of the roller device (20), opposite the first rotor unit (22), there is a second rotor unit (26) which is rotatably mounted such that it can be displaced longitudinally on the axle profile region (16),
a flexible pulling device (70) acts on the second rotor unit, and is arranged within the axle profile section (16), the transition profile region (14) and the handle profile region (12) and, of a displacer unit (96), which acts on said pulling device to cause axial longitudinal displacement of the second rotor unit (26) and therefore axial compression of the sponge body (60) take place.

2. The hand-held roller device as claimed in claim 1, characterized in that the second rotor unit (26) is connected to a second rotary bearing unit (28) which is mounted on the axle profile region (16) so as to be fixed against rotation, but which is longitudinally displaceable and to which the pulling device (70) is connected.

3. The hand-held roller device as claimed in claims 1 or 2, characterized in that the pulling device is formed as a Bowden cable (70).

4. The hand-held roller device as claimed in claims 1 or 2, characterized in that the pulling device is formed as a pull cable (80) having deflection rollers.

5. The hand-held roller device as claimed in claims 1 or 2, characterized in that a first elastic unit (56), in particular a spiral spring, is arranged between the first rotor unit (22) and the second rotor unit (26).

6. The hand-held roller device according to claims 1 or 2, characterized in that the second rotary bearing unit (28) is formed as a hub unit which is mounted on the axle profile region (16) so as to be fixed against rotation, but longitudinally displaceable.

7. The hand-held roller device as claimed in claim 6, characterized in that the hub unit has a guide projection unit (62) which points inward, engages in a slot (64) running axially in the axle profile region (16), and to which the pulling device is anchored.

8. The hand-held roller device as claimed in claims 1 or 2, characterized in that the axle profile region (16.1) is of telescopic design.

9. The hand-held roller device as claimed in claims 1 or 2, characterized in that the transition profile region (14) is formed as a housing profile, in which contrivances and/or deflection units for a pulling device are arranged.

10. The hand-held roller device as claimed in claims 1 or 2, characterized in that the displacer unit (96, 96.1) is formed as a handgrip (76.1) which is arranged in the handle profile region (12) such that it can be locked releasably.

11. The hand-held roller device as claimed in claims 1 or 2, characterized in that there is a third elastic unit (66), which is formed in particular as a spiral spring, which places the displacer unit (96, 96.1) under tensile stress in such a way that the necessary pulling force for axial compression of the sponge body (60) is reduced.

12. The hand-held roller device as claimed in claims 1 or 2, characterized in that the handle profile region (12) is arranged substantially at right angles to the axle profile region (16).

13. The hand-held roller device as claimed in claims 1 or 2, characterized in that the first rotor unit is designed to be longitudinally displaceable in the direction of the second rotor unit.

14. The hand-held roller device as claimed in claims 1 or 2, characterized in that
there are blocking means (32, 36, 38; 22, 24; 22.1, 24.1, 42) for the optional unlocking and locking of the rotational movement of the roller device (20).

15. The hand-held roller device as claimed in claim 14, characterized in that the first rotor unit (22) has a first profile cross-sectional contour and, in the region of the first rotor unit (22), there is a blocking unit (32; 42) that is fixed against rotation and has a corresponding matching profile cross-sectional contour, the first profile cross-sectional contour of the first rotor unit (22) may be brought releasably into form-fitting engagement with the matching profile cross-sectional contour of the blocking unit (32; 42) for the purpose of locking.

16. The hand-held roller device as claimed in claim 15, characterized in that the blocking unit (32) is arranged on a pivoting lever (36) which can be locked in a locking and unlocking position.

17. The hand-held roller device as claimed in claims 1 or 2, characterized in that the handle profile region (12), the transition profile region (14) and the axle profile region (16) are formed as a single-piece hollow profile.

18. The hand-held roller device as claimed in claims 1 or 2, characterized in that the connection of the second rotor unit to the rotor roll (50) is releasable.

19. The hand-held roller device as claimed in claims 1 or 2, characterized in that there is a third elastic unit (66), which is formed in particular as a spiral spring, which places the handgrip under tensile stress in such a way that the necessary pulling force for axial compression of the sponge body (60) is reduced.

20. The hand-held roller device as claims in claims 1 or 2, characterized in that the connection of the second rotary bearing unit to the rotor roll (50) is releasable.
